(19) United States
(12) Patent Application Publication
(10) Pub. No.: US 2021/0250834 A1
(43) Pub. Date: Aug. 12, 2021

(54) Attenuating a Signal from a Cell, Beam or Frequency in a Resource

(71) Applicant: Telefonaktiebolaget LM Ericsson (PUBL), Stockholm (SE)

(72) Inventors: Mirsad Cirkic, LINKÖPING (SE); Joel Berglund, LINKÖPING (SE); Pradeepa Ramachandra, LINKÖPING (SE)

(21) Appl. No.: 16/972,932

(22) PCT Filed: Jul. 17, 2018
(86) PCT No.: PCT/EP2018/069380

§ 371 Date: Dec. 7, 2020

(51) Int. Cl. H04W 36/30

(52) U.S. Cl. CPC H04W 36/30

(57) ABSTRACT

In one example aspect, a method is provided of a method in a node in a communications network, the method comprising determining an estimated signal parameter of a second signal received at a user equipment from a second cell, beam or frequency, wherein the estimated signal parameter is based on a measured signal parameter of a first signal received at a user equipment from a first cell, beam or frequency, in response to the estimated signal parameter, causing the second signal from the second cell, beam or frequency to be attenuated within a resource, and causing a handover command to be transmitted to the user equipment within the resource.

### TECHNICAL FIELD

Examples of the present disclosure relate to attenuating a signal from a cell, beam or frequency within a resource, for example in response to an estimated signal parameter of the signal.

### BACKGROUND

Mobility in mobile or wireless networks (including for example 5G networks) may allow the handover of a User Equipment (UE) to another cell, beam or frequency. In LTE, for example, mobility may be handled by the use of cell specific reference signals (CRS), which are broadcasted every millisecond throughout the full bandwidth. In 5G, for example, the procedure may rely on the use of channel-state-information reference signals (CSI-RS) and/or synchronization signals constituting the Synchronization Signal Block (SSBlock).

In some cases, a UE in need of handover to another cell, beam or frequency may be experiencing relatively high interference from a neighbour cell, beam or frequency, as the neighbor's signal strength may be relatively strong compared to the serving cell, beam or frequency. The interference may cause downlink messages to the UE to be incorrectly decoded. Therefore, the UE may not be able to successfully receive and decode a handover command, and may not be aware of it being reconfigured to make a handover. As a result, the UE may experience a dropped connection.

### SUMMARY

One aspect of the present disclosure provides a method in a node in a communications network. The method comprises determining an estimated signal parameter of a second signal received at a user equipment from a second cell, beam or frequency, wherein the estimated signal parameter is based on a measured signal parameter of a first signal received at a user equipment from a first cell, beam or frequency. The method also comprises, in response to the estimated signal parameter, causing the second signal from the second cell, beam or frequency to be attenuated within a resource, and causing a handover command to be transmitted to the user equipment within the resource.

Another aspect of the present disclosure provides a method in a user equipment. The method comprises measuring a first signal parameter of a first signal from a first cell, beam or frequency in a cellular communications network and determining an estimated signal parameter of a second signal from a second cell, beam or frequency in a cellular communications network based on the first signal parameter. The method also comprises transmitting an indication of the estimated signal parameter to a node in the cellular communications network to cause the second signal from the second cell, beam or frequency to be attenuated within a resource, and receiving a handover command within the resource.

A further aspect of the present disclosure provides apparatus in a node in a communications network. The apparatus comprises a processor and a memory. The memory contains instructions executable by the processor such that the apparatus is operable to determine an estimated signal parameter of a second signal received at a user equipment from a second cell, beam or frequency, wherein the estimated signal parameter is based on a measured signal parameter of a first signal received at a user equipment from a first cell, beam or frequency. The memory also contains instructions executable by the processor such that the apparatus is operable to, in response to the estimated signal parameter, cause the second signal from the second cell, beam or frequency to be attenuated within a resource, and cause a handover command to be transmitted to the user equipment within the resource.

A still further aspect of the present disclosure provides apparatus in a user equipment. The apparatus comprises a processor and a memory. The memory contains instructions executable by the processor such that the apparatus is operable to measure a first signal parameter of a first signal from a first cell, beam or frequency in a cellular communications network, determine an estimated signal parameter of a second signal from a second cell, beam or frequency in a cellular communications network based on the first signal parameter, transmit an indication of the estimated signal parameter to a node in the cellular communications network to cause the second signal from the second cell, beam or frequency to be attenuated within a resource, and receive a handover command within the resource.

Another aspect of the present disclosure provides apparatus in a node in a communications network. The apparatus comprises a determining module configured to determine an estimated signal parameter of a second signal received at a user equipment from a second cell, beam or frequency, wherein the estimated signal parameter is based on a measured signal parameter of a first signal received at a user equipment from a first cell, beam or frequency. The apparatus also comprises a first causing module configured to cause the second signal from the second cell, beam or frequency to be attenuated within a resource in response to the estimated signal parameter, and a second causing module configured to cause a handover command to be transmitted to the user equipment within the resource.

A further aspect of the present disclosure provides apparatus in a user equipment. The apparatus comprises a measuring module configured to measure a first signal parameter of a first signal from a first cell, beam or frequency in a cellular communications network, and a determining module configured to determine an estimated signal parameter of a second signal from a second cell, beam or frequency in a cellular communications network based on the first signal parameter. The apparatus also comprises a transmitting module configured to transmit an indication of the estimated signal parameter to a node in the cellular communications network to cause the second signal from the second cell, beam or frequency to be attenuated within a resource, and a receiving module configured to receive a handover command within the resource.

### BRIEF DESCRIPTION OF THE DRAWINGS

For a better understanding of examples of the present disclosure, and to show more clearly how the examples may be carried into effect, reference will now be made, by way of example only, to the following drawings in which:

FIG. 1 is a flow chart of an example of a method in a node in a communications network;

FIG. 2 is a flow chart of an example of a method 200 in a user equipment;

FIG. 3 is a flow chart of an example of a method that may be carried out by a node such as for example associated with a serving cell, beam and/or frequency;

FIG. 4 shows an example of apparatus in a node in a communications network;

FIG. 5 shows an example of apparatus in a user equipment;

FIG. 6 shows an example of apparatus in a node in a communications network; and

FIG. 7 shows an example of apparatus in a user equipment.

### DETAILED DESCRIPTION

The following sets forth specific details, such as particular embodiments or examples for purposes of explanation and not limitation. It will be appreciated by one skilled in the art that other examples may be employed apart from these specific details. In some instances, detailed descriptions of well-known methods, nodes, interfaces, circuits, and devices are omitted so as not obscure the description with unnecessary detail. Those skilled in the art will appreciate that the functions described may be implemented in one or more nodes using hardware circuitry (e.g., analog and/or discrete logic gates interconnected to perform a specialized function, ASICs, PLAs, etc.) and/or using software programs and data in conjunction with one or more digital microprocessors or general purpose computers. Nodes that communicate using the air interface also have suitable radio communications circuitry. Moreover, where appropriate the technology can additionally be considered to be embodied entirely within any form of computer-readable memory, such as solid-state memory, magnetic disk, or optical disk containing an appropriate set of computer instructions that would cause a processor to carry out the techniques described herein.

Hardware implementation may include or encompass, without limitation, digital signal processor (DSP) hardware, a reduced instruction set processor, hardware (e.g., digital or analogue) circuitry including but not limited to application specific integrated circuit(s) (ASIC) and/or field programmable gate array(s) (FPGA(s)), and (where appropriate) state machines capable of performing such functions.

An example handover procedure involves the configuration in the UE of measurement related aspects by the SgNB, which includes what reference signals to be measured by the UE, when the UE can trigger a measurement report and what to be included in the measurement report. In New Radio (NR), it may be possible to request the UE to include cell and beam level measurements in the measurement report. The requested measurements could be either based on the SSBlocks or the CSI-RSs. Once a measurement report (e.g. MeasResults Information Element, IE) is transmitted to the SgNB, the UE will await for a decision from the SgNB (i.e. whether it should perform access to the target gNB, TgNB, or not). At that point in time, it is possible that the radio link between the UE and the SgNB has degraded further and the probability of successful reception of handover command from the SgNB may be reduced.

Some examples of handovers may include ability to blank certain subframes (e.g. cease transmission of a signal in those subframes) by the target cell to improve the SINR situation between the SgNB and the UE. For example, a first UE (UE A) is served by base station 1 (BS 1) and UE B is served by BS 2. UE B may be static and downloading and uploading traffic. UE A may be moving towards BS 2 and may arrive at the cell border of the cell associated with BS 1 and may be in need of a handover to BS 2. Downlink messages from BS 1 to UE A may experience strong interference with signals from BS 2. To reduce the interference, BS 1 can request BS 2 to blank its transmissions on the resources (e.g. subframes) used for downlink transmissions (especially on the PDSCH for example).

In some cases, UEs at the cell edge (e.g. UE A) in need of handover may be experiencing relatively high interference, as the neighbor's signal strength (e.g. from BS 2) may be relatively strong compared to the serving cell. The interference could be from multiple beams of the same neighbor or different beams of different neighbors. A low SINR between the serving cell and the UE may cause the downlink messages to be incorrectly decoded. For example, in some cases this may mean that the UE is not able to receive the handover command successfully and hence may not be aware of it being reconfigured to make a handover. This may lead to a dropped connection by the UE.

In some examples of this disclosure, the risk of handover failure is reduced by allowing the network to attenuate or blank the appropriate neighbors' transmissions on resources used for transmitting the handover decision to the UE based on historical information and/or the measurement report as sent by the UE. For example, based on a measured signal parameter from a first cell, beam or frequency (e.g. the serving cell, beam or frequency), a signal parameter of a second cell, beam or frequency (e.g. the target cell, beam or frequency or another cell, beam or frequency) could be estimated. The estimated signal parameter, which may indicate for example the estimated signal strength at a UE of a signal transmitted by the second cell, beam or frequency, could then be used to decide whether to blank or attenuate a signal from the second cell, beam or frequency in a resource (e.g. one or more resource blocks, RBs). Additionally or alternatively, the estimated signal parameter could in some examples be used to decide whether a handover should take place (e.g the second signal is estimated to have a high signal strength, and thus the associated cell, beam or frequency could be a target for a handover). A handover command could then be transmitted to the UE within the resource.

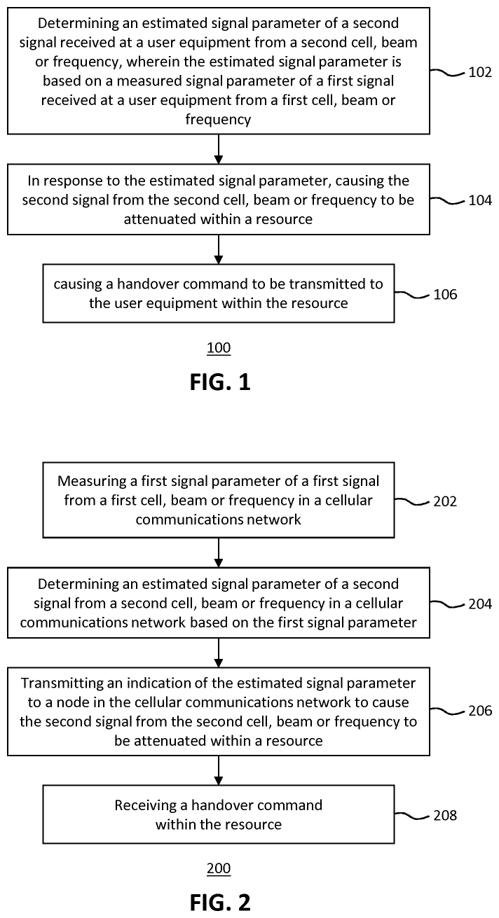

FIG. 1 is a flow chart of an example of a method 100 in a node in a communications network. The node in the communications network may comprise for example a serving base station of a UE that may need a handover, another node associated with the serving base station, or another node. The method comprises, in step 102, determining an estimated signal parameter of a second signal received at a user equipment from a second cell, beam or frequency, wherein the estimated signal parameter is based on a measured signal parameter of a first signal received at a user equipment from a first cell, beam or frequency. For example, the UE may measure the signal parameter of the first signal, which may be received from a serving cell, beam or frequency or another cell, beam or frequency, and send the first signal parameter (directly or indirectly) to the node carrying out the method 100. The node may then estimate the estimated signal parameter from the measured signal parameter. Alternatively, for example, the UE may estimate the estimated signal parameter and send this to the node (e.g. in a measurement report).

The method 100 also comprises, in step 104, in response to the estimated signal parameter, causing the second signal from the second cell, beam or frequency to be attenuated within a resource. For example, if the estimated signal parameter indicates that it interference of the second signal at the UE may be high (e.g. signal strength is above a threshold level, and/or signal strength is a predetermined proportion of the strength of another signal, such as for example the strength of a signal from the serving cell, beam or frequency), the method 100 may cause the second signal to be attenuated (e.g. reduced in strength or switched off) within the resource. Step 106 comprises causing a handover command to be transmitted to the user equipment within the resource. Thus, the handover command may be received at the UE successfully as interference at the UE by the second signal has been reduced or eliminated.

In some examples, determining the estimated signal parameter comprises receiving an indication of the measured signal parameter, and calculating the estimated signal parameter based on the indication. Thus, for example, the node implementing the method 100 may calculate the estimated signal parameter based on the measured signal parameter. Alternatively, for example, determining the estimated signal parameter comprises receiving an indication of the estimated signal parameter (e.g. from the UE or another node). Thus, the UE or another node may calculate the estimated signal parameter.

In some examples, the resource comprises one or more resource blocks, frames, subframes, time slots and/or frequency ranges. The resource may comprise for example only those resources that will be used to transmit the handover request to the UE. In some examples, other resources may also be attenuated, such as for example resource blocks adjacent (in frequency and/or time) to the resources used to transmit the handover request.

In some examples, causing the second signal to be attenuated within a resource comprises sending at least one instruction to a second node associated with the second cell, beam or frequency to attenuate the second signal within the resource. Thus the node implementing the method 100 may be able to control whether the second signal is attenuated and/or what resources are attenuated. For example, if the node implementing the method 100 is associated with the serving cell, beam or frequency (e.g. is a base station of the serving cell, beam or frequency, a network controller or another associated node), the instruction may indicate the resource in which the serving cell, beam or frequency intends to send the handover request. In some examples, causing the handover command to be transmitted to the user equipment within the resource comprises sending the handover command to the user equipment within the resource.

The handover command is a command for the user equipment to handover to the second cell, beam or frequency. Thus for example the estimated signal parameter may indicate that it is estimated that the second signal may be strong at the UE. In some examples, therefore, the estimated signal parameter of the second signal could be used to decide whether the UE should be handed over to the second cell, beam or frequency. Causing the second signal to be attenuated within a resource may in some examples comprise sending an instruction to a second node (e.g. target gNB, TgNB) associated with the second cell, beam or frequency to attenuate the second signal in response to the instruction.

Causing the second signal to be attenuated within a resource may in some examples comprise causing the second node to stop attenuating the second signal in response to a signal sent to the second node by the user equipment or a signal sent on the second cell, beam or frequency by the user equipment. For example, the signal sent by the user equipment comprises a random access preamble. Therefore, for example, receipt of the signal sent to the second node by the UE may be an indication that the UE has successfully received the handover command and is attempting to communicate using the second cell, beam or frequency, and thus may also be an indication that attenuation of resources on the second cell, beam or frequency can be discontinued.

In some examples, the method 100 comprises causing the first signal from the first cell, beam or frequency to be attenuated within the resource. For example, the first signal may also be interfering at the UE and may reduce the possibility that the UE can successfully receive a handover command. For example, the handover command may be received from a node associated with a serving cell, beam or frequency for the UE that is not the first cell, beam or frequency.

In some examples, the measured signal parameter comprises a measured reference signal strength or a measured Channel State Information Reference Signal (CSI-RS), and/or the estimated signal parameter comprises an estimated reference signal strength or an estimated Channel State Information Reference Signal (CSI-RS).

In some examples, causing the second signal from the second cell, beam or frequency to be attenuated within a resource comprises causing the second signal not to be transmitted within the resource. Thus, for example, transmissions within the resource may be switched off. Transmissions in other resources (e.g. neighbouring resource blocks in time and/or frequency) may or may not be continued in some examples.

In some examples, causing the second signal from the second cell, beam or frequency to be attenuated within the resource is performed in response to the estimated signal parameter satisfying one or more criteria. The one or more criteria could be for example the estimated signal parameter exceeding a predetermined threshold, and/or the estimated signal parameter exceeding the measured signal parameter. Any other suitable property of the estimated signal parameter may additionally or alternatively be used.

In some examples, determining the estimated signal parameter comprises determining the estimated signal parameter based on at least one of a previous measured signal parameter of the first signal received at the user equipment from the first cell, beam or frequency, a previous measured signal parameter of the first signal received at another user equipment from the first cell, beam or frequency, a measured signal parameter of the second signal received at the user equipment from the second cell, beam or frequency, a measured signal parameter of the second signal received at another user equipment from the second cell, beam or frequency, a location of the user equipment, a distance of the user equipment from a base station associated with the second cell, beam or frequency, and/or a velocity of the user equipment, and/or any other suitable previous measured signal parameter. Thus for example historical information relating to measured signal parameters, which may be measured by the UE and/or any other UE, may be considered. In an example, the UE or another UE may previously measure a signal parameter of the first signal and the second signal (e.g. at a particular location), and later the UE (e.g. at the same location or another location) may measure the first signal parameter and use the measurement to estimate the second signal parameter based on the previous measurements. In some examples, the estimated signal parameter is determined based on one or more of a signal strength of a signal from the second cell, Channel State Information Reference Signal (CSI-RS) of a reference signal from the second cell, distance from a base station of the second cell, and/or velocity to the parameter estimation model.

FIG. 2 is a flow chart of an example of a method 200 in a user equipment (UE). The method 200 comprises, in step 202, measuring a first signal parameter of a first signal from a first cell, beam or frequency in a cellular communications network, and in step 204, determining an estimated signal parameter of a second signal from a second cell, beam or frequency in a cellular communications network based on the first signal parameter. The method 200 also comprises, in step 206, transmitting an indication of the estimated signal parameter to a node in the cellular communications network to cause the second signal from the second cell, beam or frequency to be attenuated within a resource, and in step 208, receiving a handover command within the resource. Thus the handover command may be received with good reliability as interference from the second signal is reduced or eliminated for the handover command.

In some examples, the method 200 comprises performing random access to the second cell, beam or frequency. Thus the second cell, beam and/or frequency may be the target cell, beam and/or frequency. In some examples, performing random access may cause the second cell, beam and/or frequency to resume the second signal as the random access may be understood as an indication that the handover command has been successfully received at the UE.

In some examples, transmitting the indication to the node in the cellular communications network causes the node to send at least one instruction to a second node associated with the second cell, beam or frequency to attenuate the second signal within the resource. The node in the cellular communications network may in some examples be a node associated with the UE's serving cell, beam and/or frequency, such as for example a serving base station or SgNB.

In some examples, the handover command is a command for the user equipment to handover to the second cell, beam or frequency. Thus the second cell, beam and/or frequency may be the target cell, beam and/or frequency. Transmitting the indication to the node in the cellular communications network may cause the node to send an instruction to a second node (e.g. target base station or TgNB) associated with the second cell, beam or frequency to attenuate the second signal in response to the instruction. In some examples, the method 200 comprises sending a signal to the second node, or sending a signal on the second cell, beam or frequency, to cause the second node to stop attenuating the second signal. The signal to cause the second node to stop attenuating the second signal may be a random access preamble, for example.

In some examples, the handover command is a command for the user equipment to handover to a third cell, beam or frequency. Thus the second signal is not associated with a target cell, beam and/or frequency in some examples.

Transmitting the indication to the node in the cellular communications network may in some cases also cause the first signal from the first cell, beam or frequency to be attenuated within the resource. Thus the first signal (which may be from for example a non-serving cell, beam and/or frequency) could be regarded as a source of interference and attenuated accordingly to increase the likelihood that the handover request will be received successfully by the UE.

In some examples, determining the estimated signal parameter comprises determining the estimated signal parameter based on at least one of a previous measured signal parameter of the first signal received at the user equipment from the first cell, beam or frequency, a previous measured signal parameter of the first signal received at another user equipment from the first cell, beam or frequency, a measured signal parameter of the second signal received at the user equipment from the second cell, beam or frequency, a measured signal parameter of the second signal received at another user equipment from the second cell, beam or frequency, and a location of the user equipment, a distance of the user equipment from a base station associated with the second cell, beam or frequency, and/or a velocity of the user equipment, and/or any other suitable parameter. In some examples, the estimated signal parameter is determined based on the measured signal parameter using a parameter estimation model, which may use for example one or more of these parameters.

Particular examples and embodiments will now be described.

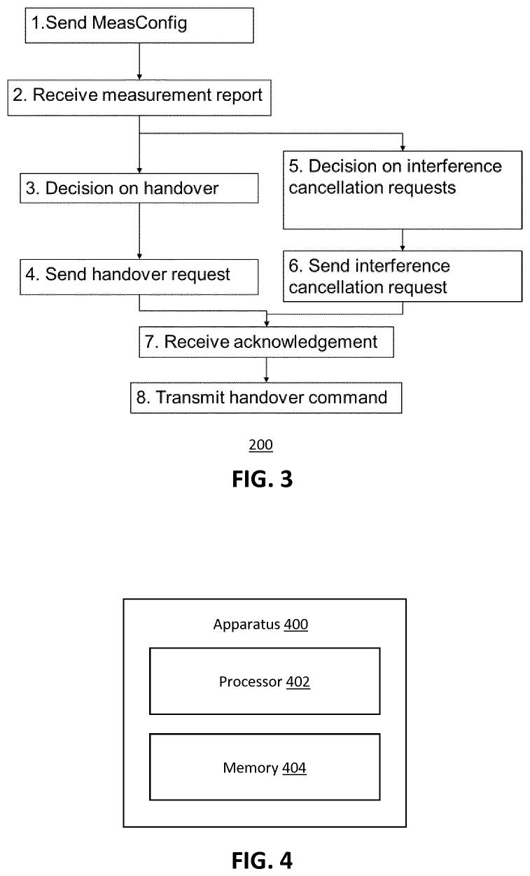

FIG. 3 is a flow chart of an example of a method 300 that may be carried out by a node such as for example associated with a serving cell, beam and/or frequency. In step 1, a MeasConfig measurement configuration is sent to the UE. This configuration may indicate one or more cells, beams and/or frequencies for the UE to measure, and may additionally indicate one or more cells, beams and/or frequencies for the UE to estimate in examples where the UE calculates the estimated signal parameter. The MeasConfig configuration may also indicate trigger criteria for measuring the measured signal parameter and/or in some examples trigger criteria to determine the estimated signal parameter.

In step 2, the measurement report is received. In step 3, a decision is made whether to handover the UE to another cell, beam or frequency. In step 4, a handover request is sent to the target cell, beam and/or frequency. However, prior to or in parallel with the handover request being sent in step 4, in step 5 a decision is made as to interference cancellation requests (e.g. requests to attenuate the second signal) is made, for example based on the estimated signal parameter, and in step 6 one or more interference cancellation requests ay be sent, so that the second signal and/or signals from one or more other cells, beams and/or frequencies may be attenuated at least within the resource(s) used to send the handover command in step 8. In step 7, an acknowledgement of the handover request is received, for example from the target cell, beam and/or frequency, and in step 8 the handover command is sent to the UE.

In particular, in step 5, the node carrying out the method 300 (e.g. a serving base station or SgNB) processes the measurement report from the UE received in step 2 to determine the target cell for the handover and the main interferers to the UE. One or more of the ‘measurements’ in the measurement report may be estimated based on other measurements and for example historical information or previous measurements. In order to make this decision, the node (e.g. SgNB) may wish to know the current radio conditions as experienced by the UE. Therefore, the node (e.g. SgNB) may in step 1 configure the UE to include multiple beam level information (for example by including maxNrofIndexesToReport of reportConfigNR to more than one) in the measurement report via a MeasConfig information element (IE). In the received measurement report (step 2), the UE may include the beam level information as measured (or estimated) by the UE.

The decision to send request for cancellation of interference could in some examples be based on one or more of the following:
The strongest beam (e.g. in terms of RSRP) from the non-serving cell is better than the strongest beam from the serving cell.
More than ‘N’ from the non-serving cells are within ‘X’ dB of the strongest beam from the serving cell. The threshold ‘N’ and/or ‘X’ could in some examples be chosen depending on the load in the non-serving cells.
The historical information of the handover statistics (based on the random access (RA) resource chosen by the UE upon performing beam specific RA in the target cell. The RA resource chosen by the UE is a good indication of which beam in the target cell is perceived to be very good by the UE at the time of performing RA).

Once the node (e.g. SgNB) decides to send an interference cancellation request to one or more of the neighboring cells, the node may send this request encompassing one or more of the following;
The beam directions (e.g. in terms of SSB index or CSI-RS index) that should be attenuated or muted by the neighbor cell
The subframe number (or subframe numbers if the node wishes to reserve multiple resources) and the resource block number (to indicate the frequency resource) when the node expects the neighbors to mute their transmissions in the aforementioned directions. This is the subframe(s) when the node intends to send the handover command to the UE in the future.

Based on this received interference cancellation request, the target cell, beam and/or frequency could in some examples decide whether it wants to attenuate its transmissions in the resource or not. If it decides to attenuate, then it may send the acknowledgement message to the node (e.g. SgNB). Although the interference cancellation request may in some examples indicate only the SSBlock (SSB) index or CSI-RS index, the neighbor cell could in some examples decide to mute its PDSCH transmissions in different directions that it has mappedto the SSB index or CSI-RS index included in the interference-cancellation request message.

In the flow chart shown in FIG. 3, the transmission of handover request to the target cell, beam and/or frequency and the transmission of an interference cancellation request message to one or more neighbor cells, beams and/or frequencies (one of which could be target cell, beam and/or frequency) are shown to be parallel operations in time but they can perform serially. For example, once the node (e.g. SgNB) receives the handover request acknowledgement message from the target cell (step 7), the SgNB could send the interference-cancellation request to the one or more identified neighbors (e.g. those neighbour(s) that are identified as transmitting a signal that could interfere with the handover command).

In some examples, by means of machine learning, a model can be trained using historical data (e.g. previous measurements and any other information) to determine one or more estimated signal parameters for one or more cells, beams and/or frequencies, which may then be used decide which cells, beams and/or frequencies should be attenuated within a resource intended for transmission of a handover command. Thus, for example, signals in whole subframes of neighboring nodes may not be attenuated and transmission in non-interfering cells, beams and/or frequencies can continue. The model could reside either at the network or UE side.

An example model is a support vector machine f(x)=ΣᵢaᵢK(xᵢ, x)+b, which consists of a predefined kernel function and whose parameters are given by xᵢ, aᵢ and b. Example of a kernel function is exp(−γ∥xᵢ−x∥²). The vector x can consist of measurements on the available source CSI-RS, source SSB and neighboring SSB. The model output can be the predicted signal strength of a neighboring cell, beam (direction) and/or frequency which can then be used to indicate which neighboring cells, beams and/or frequencies are both good candidates for handover but also interfering candidates in need of attenuation during the handover command transmission. Another example model can consist of a classifier that indicates the N strongest neighboring beams.

FIG. 4 shows an example of apparatus 400 in a node in a communications network. The apparatus 400 comprises a processor 402 and a memory 404. The memory 404 contains instructions executable by the processor 402 such that the apparatus 400 is operable to determine an estimated signal parameter of a second signal received at a user equipment from a second cell, beam or frequency, wherein the estimated signal parameter is based on a measured signal parameter of a first signal received at a user equipment from a first cell, beam or frequency. The apparatus 400 also contains instructions executable by the processor 402 such that the apparatus 400 is operable to, in response to the estimated signal parameter, cause the second signal from the second cell, beam or frequency to be attenuated within a resource, and cause a handover command to be transmitted to the user equipment within the resource.

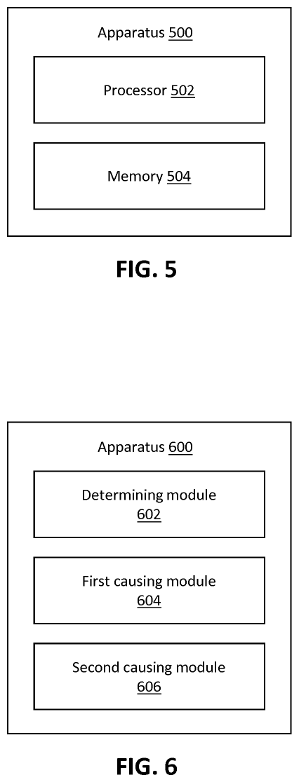

FIG. 5 shows an example of apparatus 500 in a user equipment. The apparatus 500 comprises a processor 502 and a memory 504. The memory 504 contains instructions executable by the processor 502 such that the apparatus 500 is operable to measure a first signal parameter of a first signal from a first cell, beam or frequency in a cellular communications network, and determine an estimated signal parameter of a second signal from a second cell, beam or frequency in a cellular communications network based on the first signal parameter. The apparatus 500 also contains instructions executable by the processor 502 such that the apparatus 500 is operable to transmit an indication of the estimated signal parameter to a node in the cellular communications network to cause the second signal from the second cell, beam or frequency to be attenuated within a resource, and receive a handover command within the resource.

FIG. 6 shows an example of apparatus 600 in a node in a communications network. The apparatus 600 comprises a determining module 602 configured to determine an estimated signal parameter of a second signal received at a user equipment from a second cell, beam or frequency, wherein the estimated signal parameter is based on a measured signal parameter of a first signal received at a user equipment from a first cell, beam or frequency. The apparatus 600 also comprises a first causing module 604 configured to cause the second signal from the second cell, beam or frequency to be attenuated within a resource in response to the estimated signal parameter, and a second causing module 6060 configured to cause a handover command to be transmitted to the user equipment within the resource.

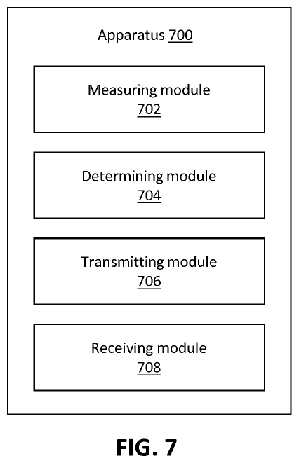

FIG. 7 shows an example of apparatus 700 in a user equipment. The apparatus 700 comprises a measuring module 702 configured to measure a first signal parameter of a first signal from a first cell, beam or frequency in a cellular communications network, and a determining module 704 configured to determine an estimated signal parameter of a second signal from a second cell, beam or frequency in a cellular communications network based on the first signal parameter. The apparatus 700 also comprises a transmitting module 706 configured to transmit an indication of the estimated signal parameter to a node in the cellular communications network to cause the second signal from the second cell, beam or frequency to be attenuated within a resource, and a receiving module 708 configured to receive a handover command within the resource.

Examples disclosed herein also include apparatus in a node in the communications network, the apparatus configured to determine an estimated signal parameter of a second signal received at a user equipment from a second cell, beam or frequency, wherein the estimated signal parameter is based on a measured signal parameter of a first signal received at a user equipment from a first cell, beam or frequency; in response to the estimated signal parameter, cause the second signal from the second cell, beam or frequency to be attenuated within a resource; and cause a handover command to be transmitted to the user equipment within the resource.

Examples disclosed herein also include apparatus in a user equipment, the apparatus configured to measure a first signal parameter of a first signal from a first cell, beam or frequency in a cellular communications network; determine an estimated signal parameter of a second signal from a second cell, beam or frequency in a cellular communications network based on the first signal parameter; transmit an indication of the estimated signal parameter to a node in the cellular communications network to cause the second signal from the second cell, beam or frequency to be attenuated within a resource; and receive a handover command within the resource.

It should be noted that the above-mentioned examples illustrate rather than limit the invention, and that those skilled in the art will be able to design many alternative examples without departing from the scope of the appended statements. The word “comprising” does not exclude the presence of elements or steps other than those listed in a claim, “a” or “an” does not exclude a plurality, and a single processor or other unit may fulfil the functions of several units recited in the statements below. Where the terms, “first”, “second” etc. are used they are to be understood merely as labels for the convenient identification of a particular feature. In particular, they are not to be interpreted as describing the first or the second feature of a plurality of such features (i.e. the first or second of such features to occur in time or space) unless explicitly stated otherwise. Steps in the methods disclosed herein may be carried out in any order unless expressly otherwise stated. Any reference signs in the statements shall not be construed so as to limit their scope.

1. A method in a node in a communications network, the method comprising:
determining an estimated signal parameter of a second signal received at a user equipment from a second cell, beam or frequency, wherein the estimated signal parameter is based on a measured signal parameter of a first signal received at a user equipment from a first cell, beam or frequency;
in response to the estimated signal parameter, causing the second signal from the second cell, beam or frequency to be attenuated within a resource; and
causing a handover command to be transmitted to the user equipment within the resource.

2. The method of claim 1, wherein determining the estimated signal parameter comprises:
receiving an indication of the measured signal parameter; and
calculating the estimated signal parameter based on the indication.

3. The method of claim 1, wherein determining the estimated signal parameter comprises:
receiving an indication of the estimated signal parameter.

4. The method of claim 1, wherein the resource comprises one or more resource blocks, frames, subframes, time slots and/or frequency ranges.

5. The method of claim 1, wherein causing the second signal to be attenuated within a resource comprises sending at least one instruction to a second node associated with the second cell, beam or frequency to attenuate the second signal within the resource.

6. The method of claim 1, wherein causing the handover command to be transmitted to the user equipment within the resource comprises sending the handover command to the user equipment within the resource.

7-19. (canceled)

20. A method in a user equipment, the method comprising:
measuring a first signal parameter of a first signal from a first cell, beam or frequency in a cellular communications network;
determining an estimated signal parameter of a second signal from a second cell, beam or frequency in a cellular communications network based on the first signal parameter;
transmitting an indication of the estimated signal parameter to a node in the cellular communications network to cause the second signal from the second cell, beam or frequency to be attenuated within a resource; and
receiving a handover command within the resource.

21. The method of claim 20, further comprising performing random access to the second cell, beam or frequency.

22. The method of claim 20, wherein determining the estimated signal parameter comprises calculating the estimated signal parameter based on the indication.

23. The method of claim 20, wherein the resource comprises one or more resource blocks, frames, subframes, time slots and/or frequency ranges.

24. The method of claim 20, wherein transmitting the indication to the node in the cellular communications network causes the node to send at least one instruction to a second node associated with the second cell, beam or frequency to attenuate the second signal within the resource.

25. (canceled)

26. The method of claim 20, wherein transmitting the indication to the node in the cellular communications network causes the node to send an instruction to a second node associated with the second cell, beam or frequency to attenuate the second signal in response to the instruction.

27-28. (canceled)

29. The method of claim 20 wherein the handover command is a command for the user equipment to handover to a third cell, beam or frequency.

30. The method of claim 20, wherein transmitting the indication to the node in the cellular communications network causes the first signal from the first cell, beam or frequency to be attenuated within the resource.

31. The method of claim 20, wherein the first signal parameter comprises a measured reference signal strength or a measured Channel State Information Reference Signal (CSI-RS), and/or the estimated signal parameter comprises an estimated reference signal strength or an estimated Channel State Information Reference Signal (CSI-RS).

32-34. (canceled)

35. The method of claim 20, wherein determining the estimated signal parameter comprises determining the estimated signal parameter based on at least one of:
a previous measured signal parameter of the first signal received at the user equipment from the first cell, beam or frequency;
a previous measured signal parameter of the first signal received at another user equipment from the first cell, beam or frequency;
a measured signal parameter of the second signal received at the user equipment from the second cell, beam or frequency;
a measured signal parameter of the second signal received at another user equipment from the second cell, beam or frequency; and
a location of the user equipment, a distance of the user equipment from a base station associated with the second cell, beam or frequency, and/or a velocity of the user equipment.

36. The method of claim 20, wherein the estimated signal parameter is determined based on the measured signal parameter using a parameter estimation model.

37. The method of claim 20, wherein the estimated signal parameter is determined based on one or more of a signal strength of a signal from the second cell, Channel State Information Reference Signal (CSI-RS) of a reference signal from the second cell, distance from a base station of the second cell, and/or velocity to the parameter estimation model.

38-39. (canceled)

40. Apparatus in a node in a communications network, the apparatus comprising a processor and a memory, the memory containing instructions executable by the processor such that the apparatus is operable to:
determine an estimated signal parameter of a second signal received at a user equipment from a second cell, beam or frequency, wherein the estimated signal parameter is based on a measured signal parameter of a first signal received at a user equipment from a first cell, beam or frequency;
in response to the estimated signal parameter, cause the second signal from the second cell, beam or frequency to be attenuated within a resource; and
cause a handover command to be transmitted to the user equipment within the resource.

41. (canceled)

42. Apparatus in a user equipment, the apparatus comprising a processor and a memory, the memory containing instructions executable by the processor such that the apparatus is operable to:
measure a first signal parameter of a first signal from a first cell, beam or frequency in a cellular communications network;
determine an estimated signal parameter of a second signal from a second cell, beam or frequency in a cellular communications network based on the first signal parameter;
transmit an indication of the estimated signal parameter to a node in the cellular communications network to cause the second signal from the second cell, beam or frequency to be attenuated within a resource; and
receive a handover command within the resource.

43-45. (canceled)
